(19) United States
(12) Patent Application Publication
(10) Pub. No.: US 2015/0337516 A1
(43) Pub. Date: Nov. 26, 2015

(54) SEGMENTED BALLAST BASE SUPPORT STRUCTURE AND RAIL AND TROLLEY STRUCTURES FOR UNSTABLE GROUND

(71) Applicant: French Development Enterprises, LLC, N. Billerica, MA (US)

(72) Inventor: William L. French, SR., Lexington, MA (US)

(21) Appl. No.: 14/703,265

(22) Filed: May 4, 2015

Related U.S. Application Data
(63) Continuation of application No. 14/222,465, filed on Mar. 21, 2014, now abandoned.
Application No. 14/222,465 is a continuation of application No. 12/658,606, filed on Feb. 10, 2010, now abandoned.

(51) Int. Cl. E02D 27/08; E02D 3/00; E04H 12/20; E02D 27/42; F03D 11/04; E02D 27/01; H02S 20/10; E02D 17/20

(52) U.S. Cl. CPC E02D 27/08; H02S 20/10; E02D 3/00; E02D 17/202; E02D 27/425; F03D 11/045; E02D 27/016; E04H 12/20

(57) ABSTRACT

Unstable ground is found in many situations in many locations around the world and causes such locations to be unsuitable for building without further support or stabilization. Unstable ground, such as landfills, can be used for beneficial purposes as opposed to lying dormant. A segmented ballast base support structure according to an embodiment of the present invention can be configured to support free-standing structures, such as solar power collection systems and wind turbines. The segmented ballast base support structure can be deployed at unstable ground sites without digging or expensive filling stabilization techniques. Segments of the base support structure can be precast at an offsite location and transported to a site in segments and sections, and can then be arranged on-site to form the segmented base support structure. The transportability of the segments of the disclosed segmented base support structure enables offsite manufacturing to be utilized.

### RELATED APPLICATIONS

This application is a continuation of U.S. application Ser. No. 14/222,465, filed Mar. 21, 2014, which is a continuation of U.S. application Ser. No. 12/658,606, filed Feb. 10, 2010. The entire teachings of the above application are incorporated herein by reference.

### BACKGROUND OF THE INVENTION

Current methods of stabilizing unstable ground require drilling, digging, filling, or other intrusive methods in order to make the unstable ground available for supporting a free-standing structure.

Unstable ground is found in many situations and in many locations around the world, and causes such locations to be unsuitable for building without further support or stabilization. Such unstable grounds can include areas of natural disasters (e.g., mudslides, earthquakes, and sink holes), areas of man-made weaknesses (e.g., landfills, brownfields, groundfills, and Superfund sites), or other surface areas that are otherwise unstable or unsuitable for normal building conditions. A person of ordinary skill in the art will note that the term “ground” as used herein does not specifically mean the soil at the surface of the earth but can be any surface, high or low (e.g., the top of building or other structure, bottom of a ravine, or basement of a building).

Prior art techniques for forming a support system for a free-standing structure include excavating the ground and pouring a cementitious or similar material directly into a form or base structure located on the site. Such prior art support systems formed on site are employed at stable ground locations such that the ground does not shift or fail before, during, or after construction of the support system. Shifting or failing ground can cause difficulty when forming the support structure and impart negative effects to any structure later connected thereto.

An example of unstable ground is a landfill, which is a site for the disposal of waste materials by burial. Historically, landfills have been the most common methods of organized waste disposal, and they remain so in many places around the world. A landfill also may refer to ground that has been filled-in with soil and rocks instead of waste materials. Landfills experience severe shaking of the ground in an earthquake and often experience internal shifting or movement due to the nature of such areas. Once materials are no longer to be added to landfills, the landfills are typically capped with a material that prevents the materials and potentially dangerous byproducts from releasing to the environment. Care is taken to avoid disturbing the cap or otherwise penetrating or disturbing the landfill.

As overcrowding of developed areas intensifies each year, land re-use strategies have become important for dormant landfills. Some of the most common usages are for parks, golf courses, and other sports fields, which do not require large free-standing structures that cannot be deployed without considerable excavation or other processes and which can be constructed without disturbing the landfill underneath.

Sites with unstable ground, such as landfills, are frequently unoccupied, wasted spaces due to lack of ground stability and because building would require increased time, effort, and expense to make the land suitable for building. Thus, such sites are continually abandoned or dormant. Because landfills and other unstable ground locations are often cleared of any natural or synthetic structures (e.g., trees or buildings), the locations can provide large areas with easy access to sunlight, wind, or other energy sources. Although such sites appear to be serviceable for building energy-collecting or generating superstructures, as described above, the grounds are too unstable absent cost prohibitive pretreatment (e.g., drilled or excavated); thus, using prior art techniques, any superstructure for supporting energy collecting or generating devices needs to be installed on a stable structure firmly connected to a stable ground. To do that, the unstable ground is currently required to be excavated or filled at specific locations or as a whole to a significant depth to provide any hope at all for providing steady support. Moreover, because landfills or other unstable grounds are predictably unstable with variability from site to site, it is difficult to anticipate how difficult excavation and other processes will be to render the area useful for supporting free-standing structures. Such unpredictability adds to reluctance of developers and municipals to commit to projects in which unstable grounds must first be excavated or filled. Therefore, vast amounts of otherwise useful geographic areas are allowed to remain dormant and void of any useful purpose.

### SUMMARY OF THE INVENTION

Embodiments of the present invention enable free-standing structures, such as solar power collection systems and wind turbine generators, to be deployed at unstable ground sites, such as landfills, brownfields, groundfills, and Superfund sites, without digging or similar pretreatment of the unstable ground.

An example embodiment of the present invention includes an apparatus (or corresponding method) comprising a base support structure for supporting a free-standing superstructure when positioned thereon on unstable ground. The base support structure can be created by interconnecting segments through use of linkages that are coupled to interconnection features of the segments in such a manner that the interconnected segments act as a unified base support structure.

The segments of the base support structure may have a wide surface area or may have a narrow surface area in the form of rails. In one embodiment, the base support structure has negligible, if any, flexibility between adjacent segments. In an alternative embodiment, the base support structure has some flexibility between adjacent segments, in which case rubber of appropriate durometer (or other material with a softness less than that of the segments) may be positioned between the adjacent segments and, further, the interconnection features and linkages enable flexing between adjacent segments in this embodiment.

The base support structure can be implemented on top of a ground treatment that can include a layer of a pliable material, such as a stabilization fabric, spanning beneath the segments, including embodiments with gaps therebetween. Above the layer of pliable material, which can be considered a bottom layer, the ground treatment can include multiple layers between the unstable ground and the base support structure such that an upper layer of the ground treatment can be sufficiently adaptable so as to track topological state changes of any of the other layers or the unstable ground beneath the layers. An example of the upper layers of the ground treatment may include a layer of selectable thickness of compactable material, such as gravel or processed material, and further optionally including a second (or more) upper layer(s) of aggregate material, such as stone. This configuration of ground treatment allows for flexibility of the ground treatment such that it can constantly adjust for, compensate for, or track topological state changes beneath the bottom layer of pliable material caused by a shifting of the unstable ground (or its cap if so configured).

In an embodiment in which the segments of the base support structure are firmly interconnected with negligible, if any, flexibility therebetween, the base support structure experiences little, if any, orientation state changes (e.g., pitch or roll) since it moves as a whole with balance of weight across its entire bottom surface area. In an embodiment in which some flexibility between adjacent segments is allowed, there may be some inter-segment orientation stage changes, but, the base support structure moves substantially as a whole with balance of its weight across its entire bottom surface; therefore, again, the base support structure as a whole experiences little, if any, orientation state changes.

In one embodiment, the base support structure is completely uncoupled from any structure firmly locked in place, such as a piling extending through the unstable ground to a stable ground below it. In an alternative embodiment, the base support structure has a limited connection to a structure firmly locked in place.

The bottom layer of the ground treatment can be a liquid permeable, pliable material that can be strong and durable so as to withstand movement from the base support structure or the unstable ground and withstand changes in orientation of segments of the base support structure, either as a unified whole or relative to other segments. The ground treatment, particularly in embodiments with the pliable material and at least one upper layer, can be implemented in a manner such that it continues to maintain sufficient integrity to serve as a platform for the base support structure such that the free-standing structure coupled to the base support structure can be maintained in a stable orientation across topological state changes of the unstable ground. Further, the segments may have grips protruding from a bottom surface to adhere to a ground treatment layer better than without the grips.

Further embodiments of the present invention include a base support structure that can support a free-standing superstructure in a stable orientation, even during extreme natural occurrences such as high winds, earthquakes, and blizzard conditions. In one embodiment, the segments of the base support structure have fixed orientation relative to other segments. In another embodiment, the segments of the base support structure can change orientation relative to the other segments as allowed by the linkages and interconnection features so as to provide segmented support for the free-standing structure, as well as allowing the forces from the superstructure to be transmitted from segment to segment at reduced levels.

The segments, ring or other shapes defined thereby, of the base support structure can be configured in any manner of shapes and sizes, including, but not limited to, circular, ovular, rectangular, square, polygonal with various angular vertices, e.g., triangular, hexagonal, octagonal, heptagonal, and irregularly shaped (e.g., jigsaw puzzle shapes), or side-by-side versions of the same. Further, the segments composing the base support structure can be of different shapes and sizes. The shape of the aggregate base support structure may be defined by the individual segments.

Further example embodiments of the present invention include segment elements that can be separable from and reattachable to corresponding segment elements of the base support structure. The base support structure can include additional segment elements assembled and interconnected vertically (i.e., an upper tier) or horizontally (e.g., “stabilizer wings”) as may be necessary to support a free-standing superstructure in a manner different from or better than the base support structure does absent the additional vertical or horizontal segments.

Example embodiments of the present invention include multiple segments and segment elements that compose the segments that are interchangeable with similar segment elements, all of which can be coupled to adjacent segments via linkages and interconnection features. The terms “segments” and “segment elements” may be used interchangeably herein. The linkages, interconnection features, and couplings for a free-standing superstructure can include at least one of the following: chamfers, sockets, cylinders, interconnected locks, bolts, latches, cables, grips, holes, clamps, guy-wires, hinges, ball joints, and ball grid arrays.

In one embodiment, the base support structure is formed through pouring cement (or other curable liquid) into a cast, and allowing the cement (or other liquid) to cure. The difference between this and the above-described embodiments is that the base support structure of this embodiment is seamless. Because trucks carrying such liquids are heavy enough to disturb the landfill, other techniques are employed to bring the liquid to a site on which the form is to be cast, such as pipeline or helicopter. While economically disadvantageous compared to the segment embodiment, casting the base support structure is still possible in this manner. Further, cement and other liquids are generally best cast at a single pouring, thus creating difficulty of having a cement mixer truck reaching a site without disturbing the landfill or other unstable ground. However, other liquids may not have a problem of being carried by very light vehicles transporting small amounts into a form over the course of a period of time (e.g., hours or days), then applying a curing agent, such as a small amount of other liquid in concentrated form or even a frequency of light (e.g., ultraviolet), thereby effectively accomplishing the same non-disturbance of the unstable ground as was done through the precast segmented embodiment described above. It should be understood that wood and other natural or synthetic materials may also be utilized to form the base support structure provided other criteria (e.g., weight bearing strength and weathering) are met.

Further embodiments of the present invention include the free-standing superstructure coupled to the base support structure, where a renewable energy power generation device may be attached to the superstructure. The free-standing superstructure can be any renewable energy power generation device such as: solar tracking systems, solar tracking systems for thermal energy, solar arrays, photovoltaics, solar cells, heat engines, wind turbines, biomass converters, or other such renewable energy power generation device as may be supported by the base support structure.

Other embodiments of the invention include treating a surface of the unstable ground to support a device, such as a renewable energy generating device, by applying a layer of pliable material, optionally applying thereon layer(s) of other materials (e.g., rocks, gravel, sand) that can adjust to changes of topological states of the pliable material caused by the unstable ground, and a base support structure as described above.

Yet another embodiment includes a landfill (or other similar area) with unstable ground, base support structure, renewable energy generation device (or other device, such as a wireless communications tower antenna) coupled to the base support structure, and, optionally, an energy storage (or communications equipment storage) facility.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a diagram of an area of unused ground on which embodiments of the present invention allow unstable ground sites to be used for collection of renewable energy.

FIG. 1B is a diagram of a segmented ballast base support structure according to an embodiment of the present invention that supports a free-standing superstructure to withstand extreme natural occurrences.

FIG. 1C is a series of diagrams of a free-standing superstructure coupled to an embodiment of the present invention that adapts to topological state changes of unstable ground beneath it.

FIG. 2A is a top view of a segmented ballast base support structure with multiple segment elements arranged in a ring shape;

FIG. 2B is a top view of a segmented ballast base support structure with multiple segment elements arranged in an octagonal shape;

FIG. 2C is a top view of a segmented ballast base support structure according to an embodiment of the present invention;

FIG. 3 is a diagram of an embodiment of the present invention that illustrates scalability of a segmented ballast base support structure;

FIG. 4 is a side view of linkages and interconnection features optionally defined on or in segments of the segmented ballast base support structure;

FIG. 5 is a side view of a ground treatment compilation used to improve support of a structure on unstable ground;

FIG. 5A is an example embodiment of a grip 550 to improve support of a structure on unstable ground by connecting with more surface lateral resistance with the ground treatment layer(s).

FIG. 6A is a diagram of a multi-tiered segmented ballast base support structure;

FIG. 6B is a side view of interconnection features between tiers of segmented ballast base support structures;

FIG. 7A is side view of a structure site according to an embodiment of the present invention that supports a rail structure with adjustable trolley structure to couple to a superstructure;

FIG. 7B is a side view of a structure site according to an embodiment of the present invention that supports a rail structure with adjustable trolley for interconnection with a superstructure;

FIG. 7C is a cross-sectional view of a beam structure according to an embodiment of the present invention that supports a rail structure with adjustable trolley for interconnection with a superstructure.

FIG. 8 is a front view of an adjustable trolley for coupling a rail structure with a superstructure according to an embodiment of the present invention; and

FIG. 9 is a diagram of a landfill on which embodiments of the present invention allow multiple renewable energy power generation devices to be implemented.

### DETAILED DESCRIPTION OF THE INVENTION

A description of example embodiments of the invention follows.

Renewable energy refers to energy generated from natural resources, such as sunlight, wind, rain, tides, or geothermal heat, which are naturally replenished. Some renewable energy power generation technologies are criticized for being intermittent, unsightly, loud, and vast in size, yet the renewable energy market continues to grow. One environmental issue surrounding renewable energy power generation technologies is the large amount of land required to harvest energy, which otherwise can be used for other purposes. Embodiments of the present invention allow for renewable energy power generation devices (“power generation devices”) to be placed or built in areas that are away from view and otherwise are not usually built upon, such as landfills, brownfields, or Superfund sites.

Example embodiments of the present invention provide a support structure for such power generation devices that can be placed or built upon unstable ground, generally considered to be ground having low bearing capacities (“unstable ground”). The support structure provided applies low ground pressure based on its ability to distribute weight across its entire bottom surface area with substantially equal distribution and without penetrating the unstable ground or cap thereon or penetrating the unstable ground but in acceptable or environmentally friendly manner. Thus, embodiments of the present invention help solve political and land availability problems regarding renewable energy power generation technologies.

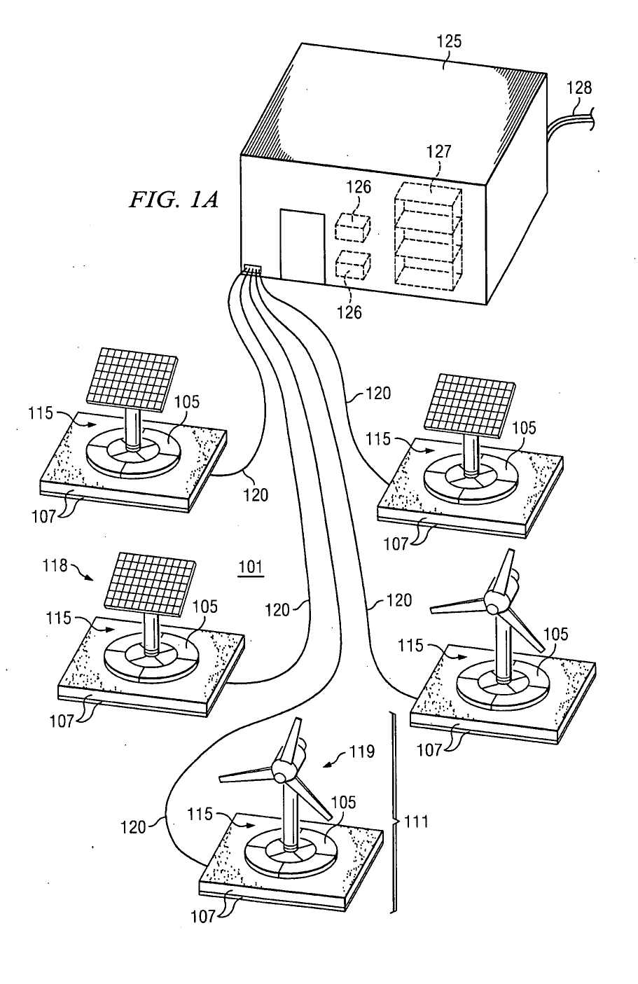

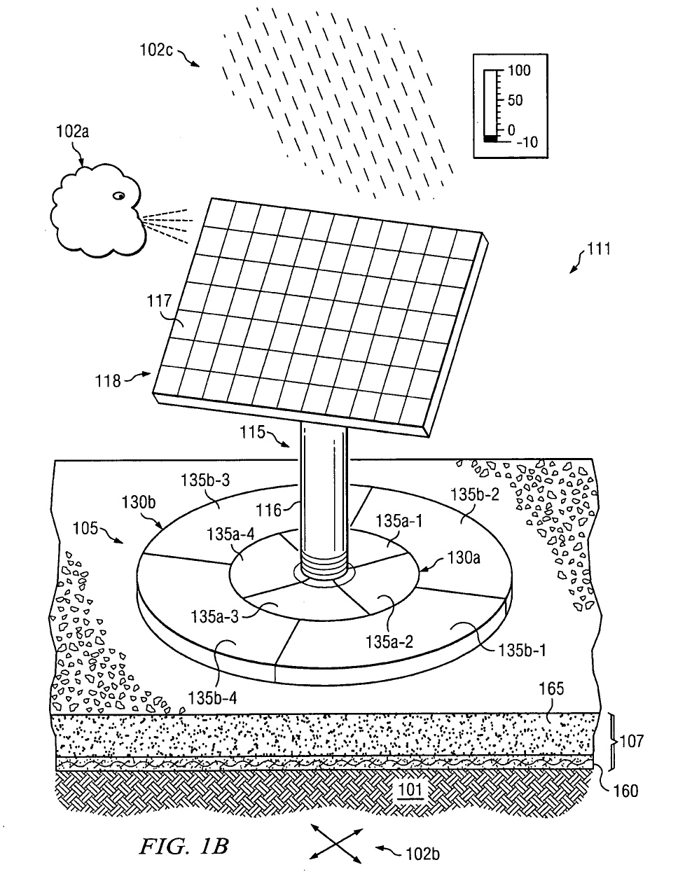

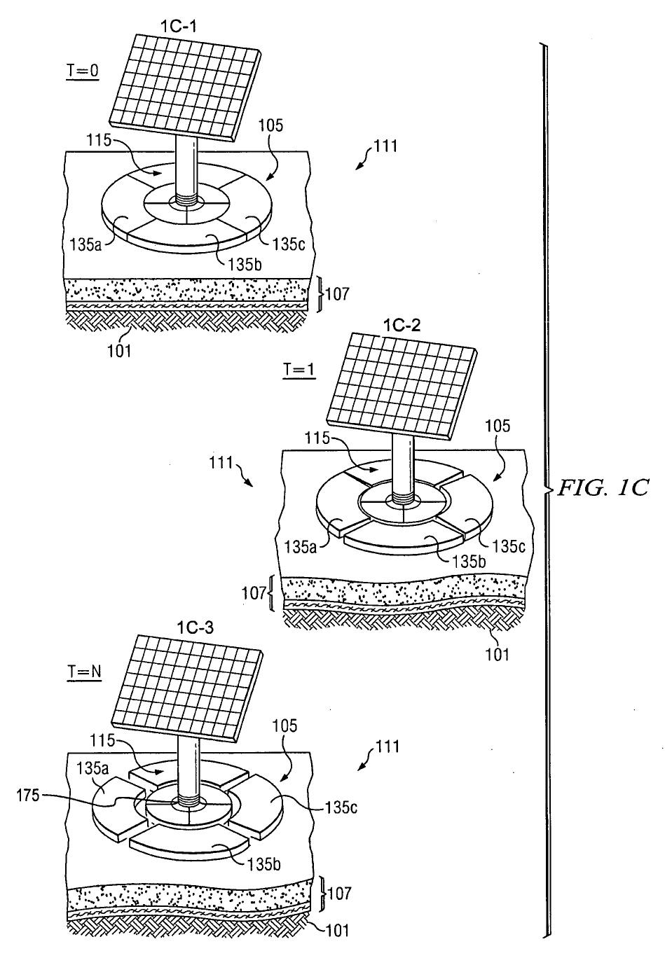

FIG. 1A is an illustration of an unstable ground 101, such as a landfill, on which an embodiment of the present invention, which includes a segmented base support structure 105, has been deployed at multiple structure sites 111. The structure sites 111 may be distributed about the unstable ground 101 in a selectable manner due to ease of deployment of the segmented base support structure 105. Ease of deployment is facilitated by segments of the segmented base support structure 105 being configured to be positioned on top of the unstable ground 101 and being configured to be interconnected at the site to form the segmented base support structure 105. The segments can be precast and transported to the structure sites 101. Optionally, the unstable ground 101 can be pretreated ground layers 107, and the segmented base support structure 105 can be assembled on the ground layers 107. Free-standing superstructures 115 can then be attached to the base support structure 105. Thus, the structure sites 111 can include ground treatment layer(s) 107, segmented base support structure(s) 105, and free-standing superstructures 115.

In another embodiment, the base support structure may be seamless through pouring of concrete into a cast at the site. Still other embodiments may be segmented or seamless and have properties as described above and below to serve as a base support structure able to meet criteria or requirements for use on an unstable ground. For purposes of example only, the embodiments presented below focus on a segmented base support structure, but it should be understood that the teachings herein apply to a seamless base support structure embodiment, as well.

The free-standing superstructures 115 can support renewable energy power generation, such as solar power collection assemblies 118 or wind power collection assemblies 119, and other types of devices, such as wireless tower antennas associated with base transceiver stations. The power generation devices 118 and 119 can transmit collected or generated energy to an energy storage facility 125 via energy transmission cables 120. The energy storage facility 125 can contain energy storage battery units 126 or other energy storage device known in the art, optionally physically organized on energy storage shelving unit(s) 127. Further, the energy storage facility 125 can include switches (not shown) to provide energy directly to the outside world without intermediate storage or provide stored energy from the batteries 126, where both sources of energy can be delivered to the outside world via energy access cable(s) 128. It should be understood that the “outside world” may be power transmission cables of a power grid (not shown), electric powered vehicles that get recharged at the energy storage facility 125, or other systems that consume or transport electric power.

In some embodiments, the base support structure 105 can be configured to support multiple different superstructures simultaneously, such as the solar power collection assemblies 118 and wind power collection assemblies 119. Further, multiple base support structures 105 can be mechanically coupled together and provide support for superstructures larger than one base support structure 105 can support on its own.

FIG. 1B is a diagram of a structure site 111 employing an example embodiment of the present invention that includes the ground treatment 107 and base support structure 105 on which a free standing superstructure 115 is installed. The free-standing superstructure 115 can be a solar power collection assembly 118 using any commercially available or custom designed free-standing superstructure components, such as a shaft or pole 116, to which a static or dynamic device can be attached, such as a solar panel array 117 or wind turbine (not shown), respectively.

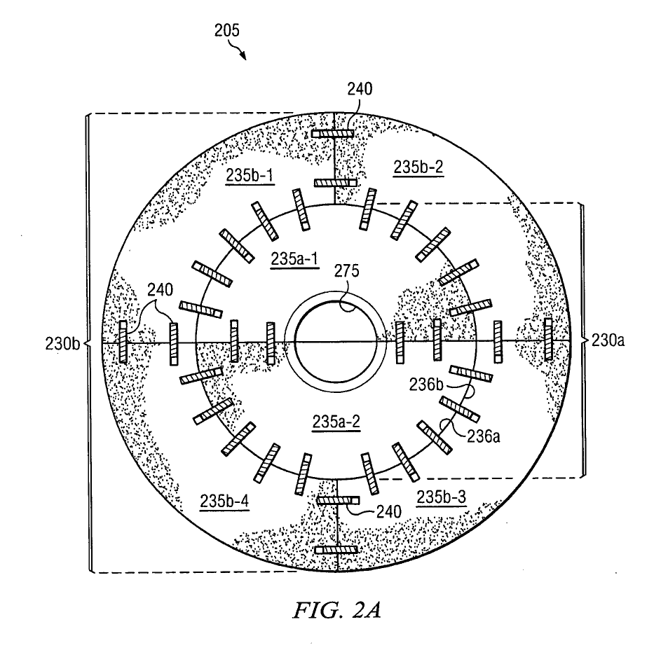

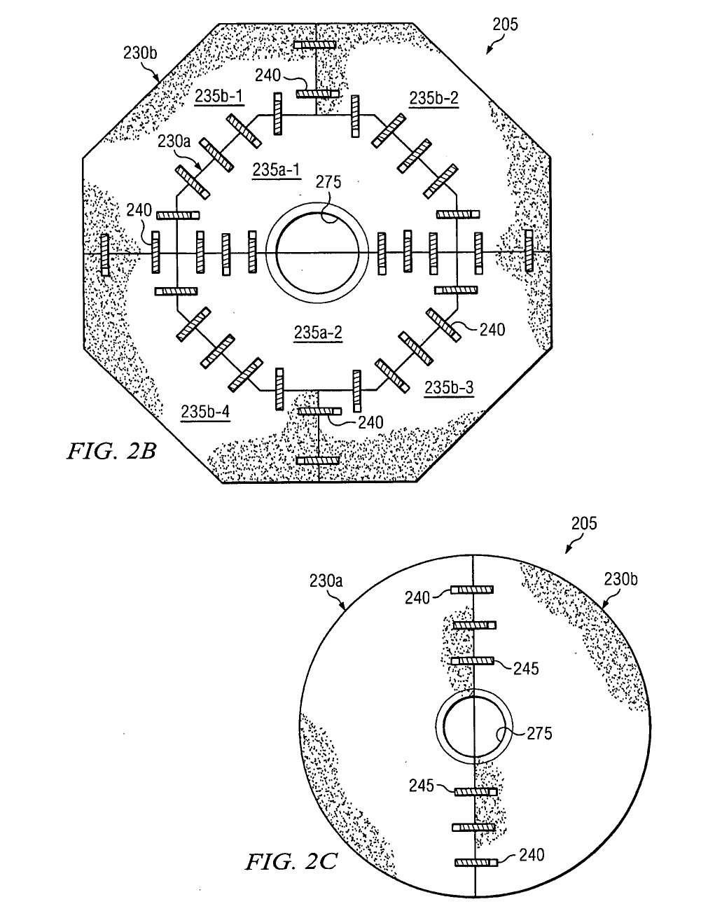

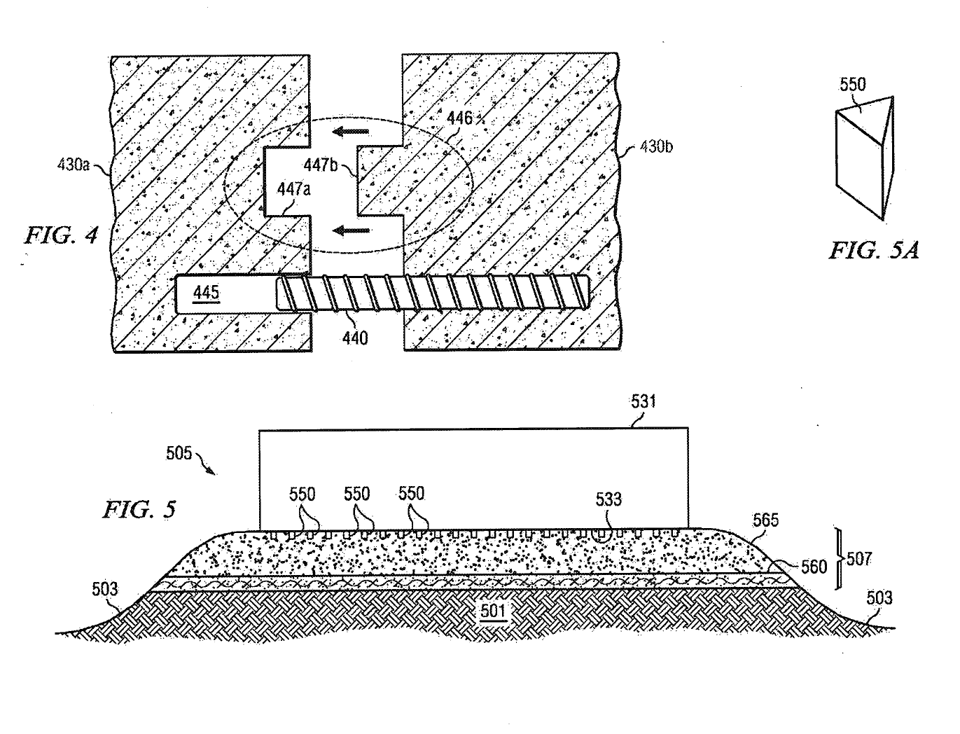

The base support structure 105 can be assembled using multiple segments 130a, 130b, which may be assembled using multiple segment elements 135a-1 . . . 4 and 135b-1 . . . 4, attached via linkages and interconnection features (shown in FIGS. 2A-2C and 4 and described in reference thereto) in order to form a unified base support structure, which is simply a base support structure in an assembled state. The terms “base support structure” and “unified base support structure” may be used interchangeably herein.

The base support structure 105 can be cementitious and precast at an off-site location for transportation to the unstable ground location. Alternatively, casting may be done in situ. Further, the base support structure 105 can be made of other materials, such as metals, or combination of materials. Regardless of the manufacturing process or materials, assembly or partial assembly can be done at the structure sites 111, allowing for low cost transportability and handleability, among the technical benefits provided by the segmented base support structure 105.

Further, because the base support structure 105 can be placed on the surface of the unstable ground, no digging, excavation, or filling of the unstable ground is necessary. In other words, the base support structure can be precast to whatever size and form necessary, in as many segments or segment elements as is necessary, and be transported in multiple segments for unification on site. Using this “segments” and “segment elements” approach makes realizable a base support structure that would otherwise be a massive and extremely heavy apparatus and, potentially, not be transportable.

Once the multiple segments and segment elements according to an embodiment of the present invention are linked via linkages (not shown) on the unstable ground 101, the segments form a unified base support structure 105 that acts as both a unified structure and, in some embodiments, a distributed segment structure, generally dispersing weight and other forces evenly across the structure and ground unless otherwise configured. In cases in which the base support structure 105 is positioned on muddy surfaces, the base support structure 105 may take advantage of suction (i.e., at each segment or segment element). If the segments or segment elements have gaps therebetween, the suction locations can be considered distributed, allowing the structure 105 to withstand loss of suction forces at a subset of segments or segment elements, such as due to erosion of soil beneath the subset. Because the base support structure 105 is unified yet distributes weight, it can be capable of withstanding extreme conditions, such as high winds 102a, earthquakes 102b, and blizzard conditions 102c, while maintaining its integrity and supporting the free-standing superstructure 115 in a substantially stable orientation.

FIG. 1C is an illustration of a structure site 111 employing an embodiment of the present invention, having an amount of flexibility between segments or segment elements, over multiple time periods (T=0, 1, N) 1C-1, 1C-2, and 1C-3. As illustrated in FIG. 1C at time T=0 1C-1, which may be just after assembly, the unstable ground 101 is considerably flat and without movement, allowing the ground treatment 107 and base support structure 105 positioned thereon to be relatively even and calm, sometimes referred to as a nominal state. Because the base support structure 105 and ground treatment 107 are in a nominal state relative to the unstable ground 101, the segments of the base support structure are in their assembled orientations relative to each other.

At time T=1 1C-2, the unstable ground 101 has shifted (i.e., experienced a topological state change) due to some external force or internal movement. Because the multiple segment elements 135a-c are configured to retain characteristics of interconnected segments, thus, capable of changing orientation relative to each other as a function of the linkages and interconnection features (not shown), the base support structure 105 is able to maintain support of the superstructure 115 with substantially the same orientation relative to its orientation at T=0. In the center of the inner ring structure (such as 135a-1-135a-4 as shown in FIG. 1B), or other segment(s) of the base structure as may be required by the characteristics of the site and superstructure, are superstructure connection coupling(s) 175 sized and spaced to bear the superstructure.

At time T=N 1C-3, the unstable ground 101 has further shifted due to some external force or internal movement, and the multiple segment elements 135a-c likewise change orientation relative to each other. The ability of the multiple segment elements to change orientation as a function of the linkages and interconnection features upon shifting unstable ground allows for the constant stabilization of the free-standing superstructure 115 without exceeding structural limits of the overall base support structure 105 or allowing the superstructure 115 to collapse or tip.

In an embodiment in which the segments elements 135a-c of the base support structure 105 cannot change orientation relative to each other, the base support structure 105 if deployed on the unstable ground 101 of FIG. 1C would not have angles between the segment elements 135a-e and would only pitch or roll a minor amount, if at all, from T=0 1C-1 to T=N 1C-3. Further, any amount of pitch and roll can be compensated for in some embodiments through mechanical adjustments between the base support structure 105 and superstructure 115. Because the embodiment in which the segment elements 135a-c do not change orientation relative to each other has properties that are clearer than the embodiment having flexibility between the segment elements 135a-c, the description below addresses the latter embodiment in more particular detail.

FIG. 2A is a top view of an example embodiment of the present invention illustrating a segmented ballast base support structure (“base support structure”) 205 deployed on top of a ground treatment (not shown), which can be formed on or applied to the surface of unstable ground (not shown). The base support structure 205 can include two or more segments 230a-b, which, in turn, can each be defined by multiple respective segment elements 235a-1, 2 and 235b-1 . . . 4. The segment elements can be interchangeable with corresponding segment elements in some embodiments if the corresponding segments are the same (e.g., shape, size, and interconnection features).

In the example embodiment of FIG. 2A, the first and second segments 230a and 230b are ring structures, such that the first segment 230a is encircled by the second segment 230b. For ease of reading with respect to FIG. 2A and other figures with multiple concentric ring structures, regardless of shape of the ring structures, the first segment 230a may be referred to as an “inner ring structure,” and the second segment 230b may be referred to as an “outer ring structure.” The inner ring structure 230a has an outside edge 236a (i.e., circumference) that essentially matches to the inside edge 236b (i.e., inner circumference) of the outer ring structure 230b. Adjacent ones of the multiple segment elements of the inner ring structure 230a are securely integrated together with linkages 240. Adjacent ones of the multiple segment elements 235b-1 . . . 4 of the outer ring structure 230b can be similarly securely integrated together with linkages 240. Adjacent ones of inner and outer segment elements are securely integrated together with linkages 240. The segment elements in an interconnected state form a unified base support structure (as in FIG. 1B), while, in some embodiments, maintain the properties and characteristics of segmented elements. It should be understood that the linkages 240 can be configured to provide selectable amounts of flexibility between adjacent segment elements, including zero flexibility. Choices of how much flexibility in potential multiple degrees of freedom (i.e., roll, pitch, and yaw, or other orientation degrees of freedom) to allow the segments to have relative to each other may be based on parameters associated with the unstable ground, materials of the segment elements, or linkages, configuration of interconnection features to which the linkages interconnect, superstructure, expected weather conditions, and so forth.

In the center of the inner ring structure 230a, or other segment(s) of the base structure as may be required by the characteristics of the site and superstructure, are superstructure connection coupling(s) 275 sized and spaced to bear the superstructure. The superstructure connection coupling(s) 275 can take on various forms, such as a raised area, beveled area, imprinted area, carved-out area, or another such connection feature and employ linkage(s) such that a superstructure (not shown) can be attached to or fitted in the base support structure 205. In alternative embodiments, the superstructure connection coupling(s) 275 can span the inner ring structure 230a and outer ring structure 230b, thereby providing a balanced load across the base support structure 205. In some embodiments, the superstructure connection coupling(s) 275 provide multi-degree of freedom movement to enable the segment elements 235a-1, 2 and 235b-1 . . . 4 to change orientation states relative to each other with more flexibility than in embodiments in which the coupling(s) 275 connect the superstructure to the segment elements with fixed orientation.

It will be understood by those skilled in the art that various changes in forms and details of embodiments of the present invention may be made herein without departing from the scope of the invention encompassed by the appended claims. For example, dimensions, materials, and shapes of elements herein can be varied depending upon the situation at hand. For example, the ring structures can be made into any shape or size. Further, features defining segments and segment elements or defined in or by surfaces of same can be formed with irregular shapes (not shown) and grooves such that each segment is only able to be connected to its specific matched element (e.g., a protruding triangular shape is matched to a recessed triangular shape). Such shapes can help to provide “instructions” or “guidelines” to follow when constructing and assembling the segmented elements on site. Further, as mentioned above, it can be useful to assemble the first and second segments of the base support structure using segmented elements thereof for many purposes, including, but not limited to, an easier ability to ship, transport, assemble, etc. each element from an origin (e.g., manufacturing plant) to a destination (e.g., landfill).

FIG. 2B is a top view of an example embodiment of the present invention illustrating a segmented ballast base support structure 205 in an octagonal formation. It should be understood that any other shape, such as a circle, polygon with vertices having more or less angle than an octagon, or random shape, may alternatively be employed. the circular and octagonal shapes are embodiments presented herein in further detail for illustration purposes only.

Continuing to refer to FIG. 2B, the first and second segments 230a and 230b, respectively, the segment elements 235a-1, 2 and 235b-1 . . . 4, and linkages 240 illustrated in FIG. 2B can be substantially the same as corresponding elements described above in reference to FIG. 2A. An advantage of forming a base support structure with an octagonal (or certain other geometric shapes) shape as compared to circular shapes is an ability to construct multiple base support structures 205 next to each other with maximized use of ground surface area. It will be understood by those skilled in the art that the segments can be formed in a multitude of different shapes and sizes as is found necessary for different sites, working conditions, styles, etc.

FIG. 2C is a top view of another example embodiment of the present invention illustrating a segmented ballast base support structure 205 composed of a first segment 230a that is located at the side of a second segment 230b and attached by linkages 240 and interconnection features 245. Such a side-by-side formation of segments is another possible configuration for the assembly of the first segment 230a and the second segment 230b. It should be understood that the side-by-side formation can be constructed similar to the inner ring segments 235a-1, 2 of FIGS. 2A and 2B, but in the embodiment of FIG. 2C, inner and outer ring segments (not shown) may each be semicircles and may have links arranged in a single axis between left and right hemispheres.

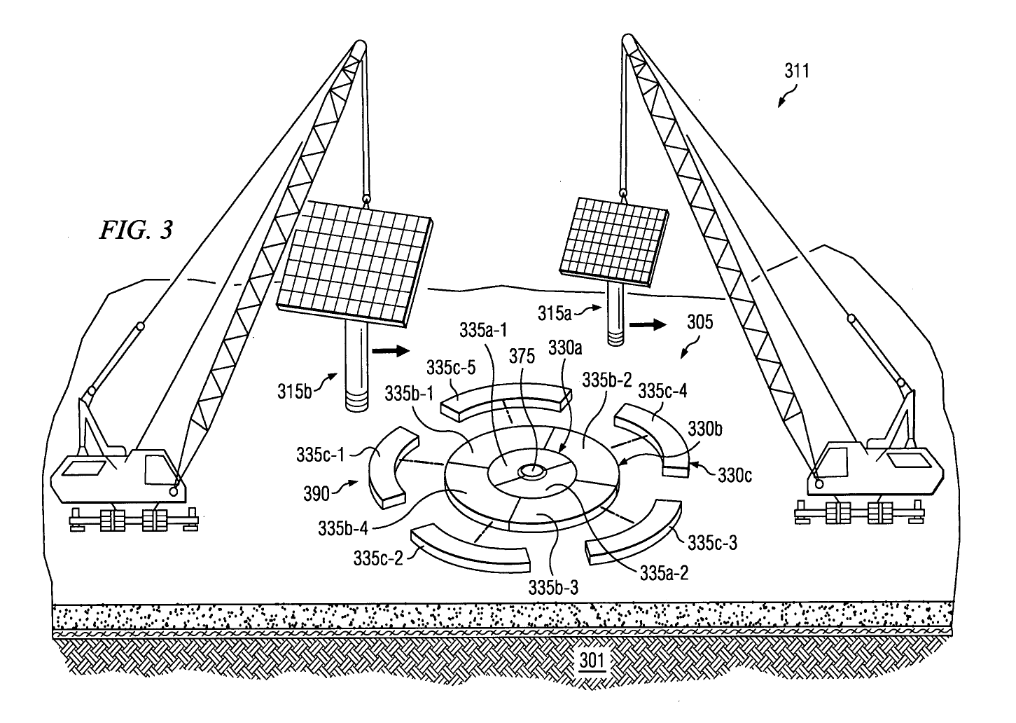

FIG. 3 is an illustration of an unstable ground 301 on which an example embodiment of the present invention, which includes a segmented base support structure 305, has been deployed.

The base support structure 305 can be assembled using multiple segments 330a and 330b, which can be assembled using multiple segment elements 335a-1, 2 and 335b-1 . . . 4, respectively, optionally cementitious and precast at an offsite location. Additional segment(s) 335c defined by segment elements 335c-1 . . . 5 can be similarly precast off site, at a same or different time, and transported to the unstable ground 301 for further assembly of the base support structure, which may be done for scalability purposes. For example, a first superstructure 315a of a certain size or type can be mounted to a base support structure 305 assembled by segments 330a and 330b. But, for whatever reason (e.g., newer model with change of type or size of superstructure or higher power generation requirements), a larger superstructure 315b is to be added to or replace a smaller superstructure 315a at the structure site 311. The change of the superstructure may drive requirements for additional or increased support by the existing base support structure 305 from one having two concentric ring structures 330a, 330b to one that necessitates three concentric ring structures. In such a case, the base support structure 305 can be enlarged by further assembly with additional segment elements 335c-1 . . . 5, in this case a third ring structure, which can be interconnected to the segment elements 335b-1 . . . 4 of the now-second ring structure 305b via linkages and interconnection features (not shown), thereby providing increased support for the larger superstructure 315b, which includes distribution of weight on the unstable ground and ability to withstand tipping or tilting forces of a larger or taller superstructure. If necessary, the superstructure connection coupling(s) 375 can be changed, enlarged, or reduced in order to interconnect with the larger superstructure 315b.

FIG. 4 is an example embodiment of the present invention illustrating a linkage 440 and corresponding interconnection feature 445 that may be used to interconnect segments 430a, b or segment elements to each other, or the free-standing superstructure to the segments or segment elements. In the case of segments or segment elements, an interlocking feature set 446, with a socket 447a defined in one segment or segment element and a tab 447b defined (in the form of cement or other material) protruding from the other segment or segment element, can be employed to make a stiffer coupling than a linkage can provide. It should be understood that no “play” (i.e. movement) or a certain amount of “play” may be allowed by the feature set 446 to allow orientations of the segments or segment elements to be different, up to a limit that causes the tab 447b or material around the socket 447a to yield. The interlocking feature set 446 may, in some embodiments, be considered a linkage (tab 447b) with interconnection feature (socket 447a).

Continuing to refer to FIG. 4, in the case of segments 430a, 430b, the first segment 430a can be securely connected to the second segment 430b using a plurality of different methods or combination of methods. For example, the first and second segments 430a, b of the base support structure can be fitted with female and male components of connector(s). The linkage 440 can be a male component extruding from the second segment 430b and an interconnection feature 445 can be a female component protruding into the first segment 430a. Alternatively, both segments 430a, b can have female (or male) components as interconnection features 445, and a male (or female) link 440 can be connected to each. Linkages 440 and interconnection features 445 can be in any formation or arrangement associated with the base support structure and superstructure so as to provide support and unification of the segments and structures. Other forms and manners of interconnecting the structures can include, for example, using tubing, piping, interconnecting shapes or forms, applying glue, etc. A plurality of these linkages and interconnection features can be used, implemented, added, and/or removed so as to provide sufficient retaining force to hold each element to another element or structure, as needed. For example, in an embodiment having flexibility between orientations of adjacent segments, on a flat surface that may experience a high degree of topological state changes, structurally softer (i.e., more flexible) interconnections may be useful to allow the segments of segment elements to track the changes. On a high slope surface, structurally stiffer (i.e., less flexible) interconnection features may be useful to maintain alignment in vertical and horizontal directions between interconnected segments.

Linkages 440 and interconnection features 445 can be implemented on all tiers and dimensions of the structures, as required. For example, linkages may be installed on the side, top, bottom, inside, outside, or around the structures and can include any one of or combination of: chamfers, bolts, latches, cables, rebar, grips, interconnected locks, ball-joints, or other forms of linkages known in the art.

In addition to the linkages, other types of supporting and reinforcing elements may be inserted, added, implemented, or integrated with the other structures as is necessary from site to site, such as interconnection features 445. For example, the linkage 440 can be a bar (e.g., rebar) embedded within a base support structure such that the segments of the base support structure are joined together by placing the rebar into an allocated hole 445 within another segment of the base support structure to interlock the two segments. Although this linkage and interconnection feature is disclosed as rebar, a number of other connecting elements may be substituted therefore. Other such interconnection features may include, but are not limited to, chamfers, sockets, cylinders, interconnected locks, cups, ball joints, etc.

The interconnecting mechanisms can be secured in a manner known in the art during or after the construction of the segmented base support structure to provide an intimate and secure contact between the structures or a loose and flexible contact between the structures.

FIG. 5 is an illustration of an unstable ground 101, such as a landfill, on which an embodiment of the present invention, which includes a segmented base support structure 505 on top of a ground treatment 507, has been deployed. The ground treatment 507 can be a compilation of materials that can be laid down on a surface layer 503 of the unstable ground 501. The ground treatment 507 can be implemented in multiple layers, of multiple forms, at multiple depths, with multiple compositions, or by multiple methods. For example, in FIG. 5, a bottom layer 560 of the ground treatment 507 is located closest to the surface 503 of the unstable ground 501. The bottom layer 560 can be any liquid permeable or impermeable base material that can increase the stability of the ground surface 503. For example, bottom layer 560 can be a geosynthetic material including, but not limited to, geotextiles, geogrids, geonets, geomembranes, geosynthetic liners, geofoam, or geocomposites. While the polymeric nature of such geosynthetic products makes them suitable for use in the ground where high levels of durability can be required, other products may also be employed. For example, the bottom layer 560 can also be any natural or synthetic liner with high-tensile strength, flexibility, and/or elongation without failure. The bottom layer 560 may be designed to withstand stresses imposed upon it by orientation differences in the segments or segment elements above it, where the stresses may be transmitted to the bottom layer via intermediate layers.

The ground treatment 507 can include multiple other layers above the bottom layer 560, for example, one or more top layers 565 (i.e., intermediate layers between the base structure and bottom layer), which can be employed using some form of sediment, e.g., gravel, rock, sand cobble, pebble, or granules. The one or more top layers 565 can also be implemented using other forms of natural or synthetic materials. Example embodiments of the present invention can use the same type of material for any of the ground treatment layers 507, but completely different materials or some combination of different and similar materials can alternatively compose the layers.

Furthermore, the base support structure 505 can be placed on top of the ground treatment 507. The base support structure 505 can have a top surface 531 and a bottom surface 533, with the bottom surface 533 being located closest (e.g., on) to the ground treatment. The bottom surface 533 can employ grips 550 in order to connect with more surface lateral resistance with the ground treatment layer(s).

FIG. 5A illustrates an example embodiment of a grip 550 having a triangular prism shape which can be used to create additional friction by connecting with more surface lateral resistance with the ground treatment layer(s).

The ground treatment bottom layer 560 may be a liquid permeable layer in situations in which it is beneficial for liquid to permeate from the unstable ground to the structure site so as to allow for a suction or suction-like effect to provide greater holding force of the base support structure and the ground treatment. Such suction may enable a subset of segment elements to do the job of a much larger base that does not have suction forces available. Forces acting on interconnected segment elements can be evenly or unevenly dispersed across the segments if suction releases in some areas but not in other areas.

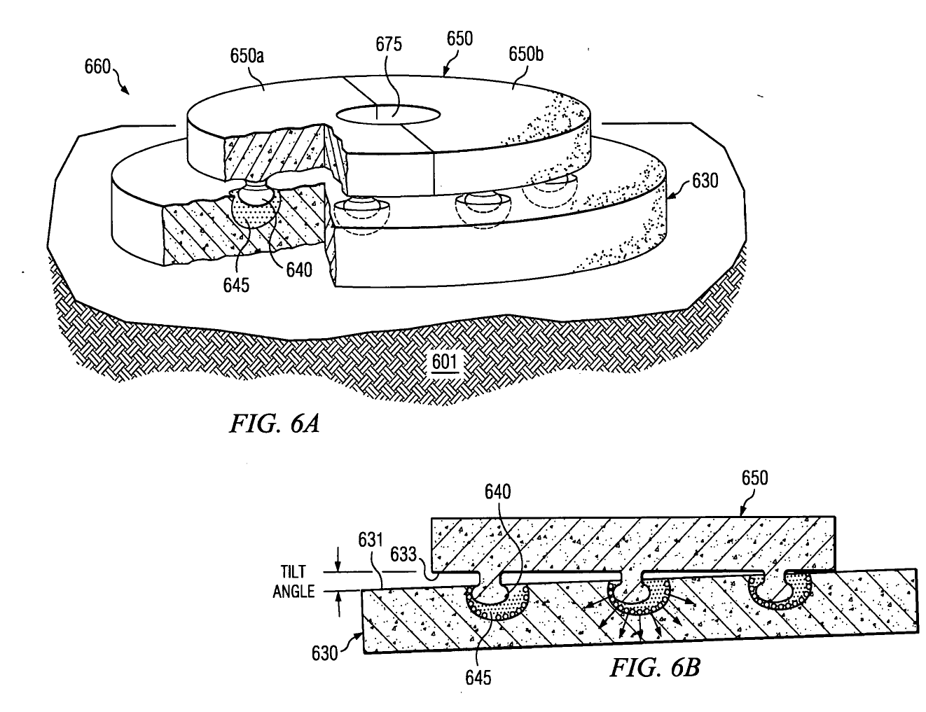

FIG. 6A is a diagram of a multi-tiered structure 660 employing an example embodiment of the present invention that includes a base support structure 630 and an upper tier structure 650. The base support structure 630 can be a base tier structure assembled on the unstable ground 601, with or without pretreatment. The upper tier structure 650 can be assembled on top of the base support structure during initial assembly of the base support structure 630 or at a later time.

The upper tier structure 650 can be assembled as a single continuous structure (e.g., a platform of any material (not shown)) or as a multi-segmented structure similar to the base support structure 630. The upper tier structure 650 can be assembled using multiple segments including a first segment 650a interconnected to a second segment 650b. Each segment 650a, 650b can be assembled using multiple segment elements (not shown), which are interconnected to each other and other segments via linkages and interconnection features in a manner described above in reference to FIGS. 2A-2C and 4.

Optionally, the upper tier structure 650 can be further configured to be interconnected to a superstructure (not shown) via superstructure connection coupling(s) 675. Some embodiments of the upper tier structure 650 can be interconnected to other segments and other tiers of structures via linkages 640 and interconnection features 645 such that the segments and multi-tiered structure can be in an interconnected state, collectively serving as a multi-tiered, unified, support structure that retains the characteristics of segmented structures as a function of the linkages and interconnection features. An example advantage of a base support structure 630 with multiple tiers is an ability to retain a horizontal position of the upper tier 650 even if the base tier 630 pitches or rolls, up to a limit defined by physical constraints, to maintain orientation of the superstructure positioned thereon.

In other embodiments of the multi-tiered structure 660, the multi-tiered structure can employ multiple different types of linkages and interconnection features such as necessary to properly disperse different weights and forces imparted onto the structure from external and internal forces (e.g., the coupled superstructure). Some embodiments of the multi-tiered structure 660 can be interconnected via a ball grid array (described in reference to FIG. 6B).

FIG. 6B is an illustration of a linkage and interconnection feature, such as a ball grid array, in which an example embodiment of the present invention can be employed to interconnect multiple tiers of a base support structure and an upper tier structure. The additional upper tier structure (as described in reference to FIG. 6A) can include multiple linkage and interconnection features (not shown) in addition to or in place of the ball grid array. A ball grid array can be implemented between two or more tiers of structures such that interconnection feature sockets 645 can be assembled in or on the top surface 631 of the bottom tier base support structure 630. Linkages can be assembled in or on the bottom surface 633 of the upper tier structure 650.

In some embodiments of the present invention, the interconnection features 645 can include movable elements (e.g., ball bearings) such that when the upper tier structure 650 is assembled on top of the bottom tier base support structure 630, and the ball grid arrays of each structure are aligned, the upper tier structure can move in connection with and reaction to the bottom tier base support structure without increasing stresses or forces between or among the structures. Further, the ball grid array technique allows forces of the upper tier structure 650 to be distributed uniformly at each ball grid location into the bottom tier of the base support structure 630. Using the ball grid array approach makes realizable a multi-tiered base support structure that can maintain stabilization of a free-standing superstructure as a function of a tilt range allowed between the upper and bottom tiers. Further, extendable links, springs, or other elements to raise or lower components of the interconnection features 645 may be employed to compensate for change in spacing due to an angle change between the upper tier structure 650 and bottom tier of the base support structure 630.

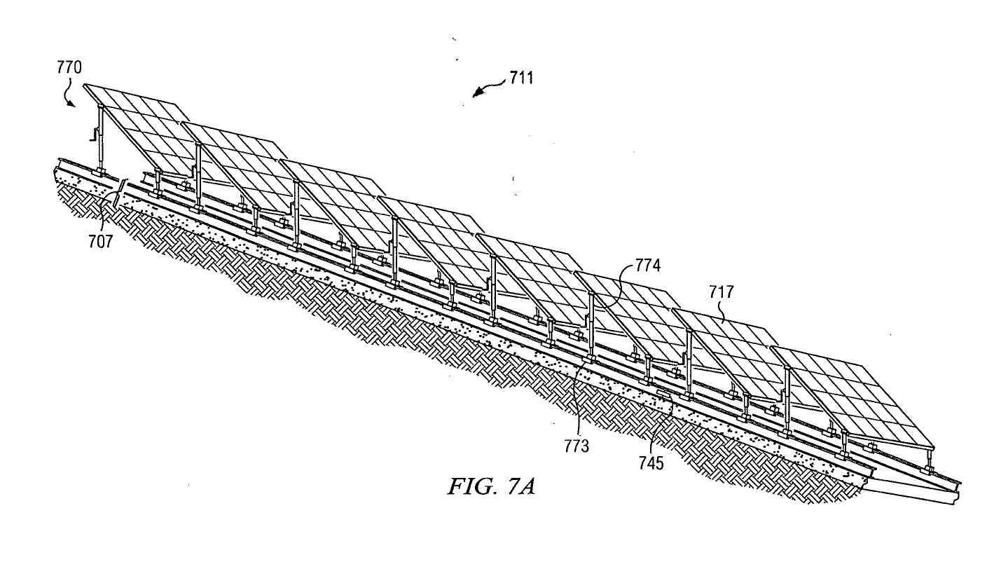

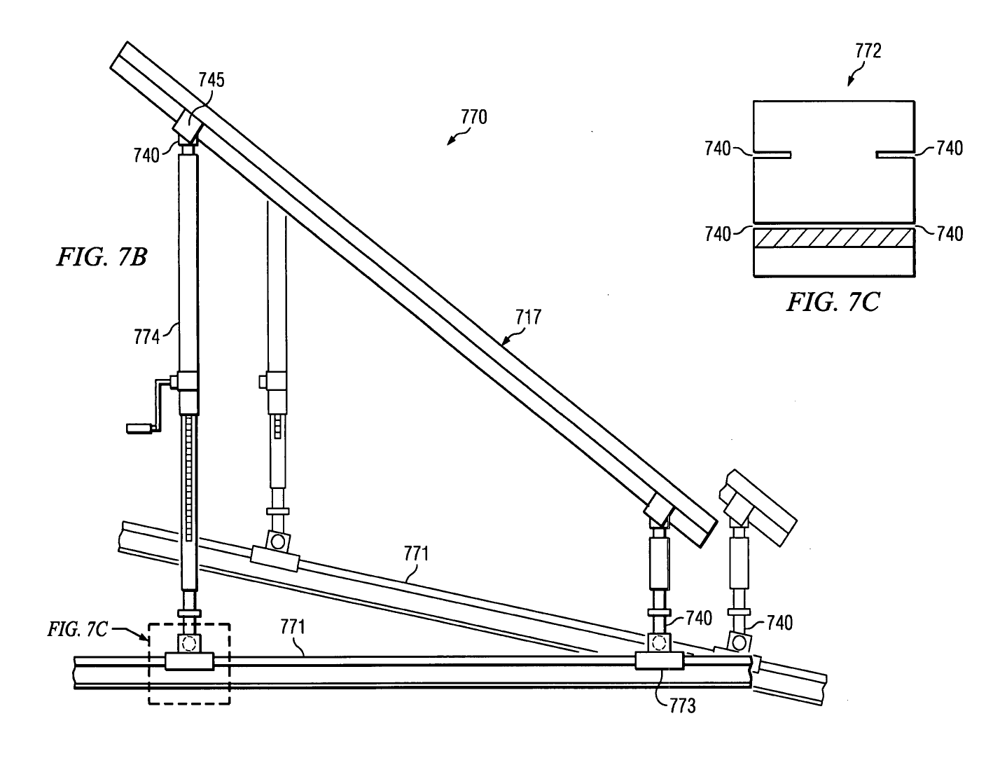

FIG. 7A is a side view of a structure site 711 employing an example embodiment of the present invention that includes the ground treatment 707 and on which a rail structure with adjustable trolley structure 770 is installed. The rail structure can be considered segments and segment elements that are linear as compared to the shapes of segments and segment elements described above (e.g., FIG. 1B, segments 130a, 130b and segment elements 135a-1 . . . 4 and 135b-1 . . . 4), wherein a pair of rails or rail segments can be considered a base support structure, so as to be easily transportable and handled. For example, multiple rail structures 771 and multiple trolley structures 773 can be precast in any available material (e.g., metal) off-site and transported to and assembled on an unstable ground site. Alternatively, the rail structure(s) 771 casting may be done in situ. The rail structures 771 can be interconnected by assembly components 740 and 745, or, alternatively, interconnection can be implemented using surface mounts or other such linkages to attach the rails and trolleys to the ground treatment, or other such apparatus or structure. The rail structures 771 can be arranged in any manner (e.g., different angles, heights, widths, etc.) as is required from site to site and can be rearranged or manipulated at a later time.

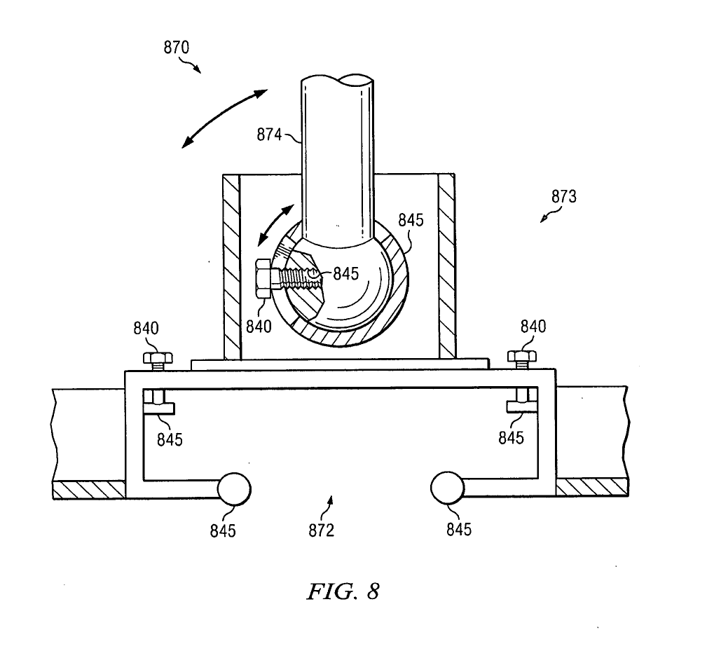

The rail structure 771 can be coupled to a beam structure (shown in FIG. 8 and described in reference thereto) in order to couple the rail structures 771 further to the adjustable trolley structures 773, which are configured to enable support and manipulation of structures or superstructures coupled thereto. Further, the adjustable trolley 773 may incorporate support legs 774 for coupling to the superstructure or superstructure component, such as solar panel array 717.

It should be understood that the forms of the rail structure with adjustable trolley structure 770 can be its own individual component deployed on a ground treatment on unstable ground. Alternatively, the rail structure with adjustable trolley structure 770 can be deployed on or integrated with (e.g., formed during precasting or casting of segments) a base support structure (not shown). An embodiment deployed on or integrated with a base support structure can include a slope adapter, such that the structure elements (e.g., rails, trolleys, base support structure, etc.) can be adjusted in any or particular direction.

FIG. 7B is an illustration of a rail structure 771, adjustable trolley structure 773, support legs 774, and superstructure 717, according to an example embodiment of the present invention. The rail structures 771, which can vary in length and dimension (e.g., 20′-50′), can be implemented or arranged on the ground treatment (not shown), or other structure, based on the parameters (e.g., width, height, weight) of the superstructure to be coupled thereto. Further, the rail structures 771 can be coupled to a beam structure 772 such that the rail structures and the beam structures form one continuous component or multiple components interconnected using assembly components 740 and 745. Further, the beam structures 772 may include corresponding, integrated or associated, mounting components 740 for interconnecting with the assembly components 740, 745 of the adjustable trolley structures 773. The rail structure with adjustable trolley structure 770 of this example embodiment is configured to support one or more support legs 774 in a manner such that the support legs 774 are configured to support a superstructure or superstructure element, such as a solar panel array 717. The rail structure with adjustable trolley structure 770 can be employed to assemble, rearrange, and/or disassemble the superstructure or superstructure elements to or from the base support structure by employing a “track” that allows ease of movement onto and off of the base support structure.

FIG. 7C is a cross-sectional view of a beam structure according to an embodiment of the present invention. The beam structure 772 supports a rail structure with adjustable trolley for interconnection with a superstructure. Further, the beam structures 772 may include corresponding, integrated or associated, mounting components 740 for interconnecting with the assembly components 740, 745 of the adjustable trolley structures 773.

FIG. 8 is a front view of an adjustable trolley structure 873, according to an example embodiment of the present invention, which includes support legs 874, deployed thereto. The adjustable trolley structure 873 can further include a gear and wrench mechanism interconnecting and securing the adjustable trolley structure 873 to the beam structures 872 by employing assembly components 840, 845 that can include: locks, racks, set screws, ball bearing sockets, ball bearing joints, ball grid arrays, ball and socket joints, support beams, etc.

In an example embodiment of FIG. 8, the support legs 874 can be configured to be adjustable (e.g., vertically, horizontally, rotationally, etc.), for example, such that the support legs 874 may be different heights at different times, or different heights relative to other support legs 874. The top portion of the support legs 874 can be interconnected to a superstructure or superstructure element (not shown), assembly components 840 and 845. The adjustable trolley structure 873 may be configured to enable manual or mechanical manipulation of the coupled support legs 874 such that the support legs 874 can sustain any calculated movements from the base support structure so as to maintain a stable orientation of the coupled superstructure as a function of the linkages and interconnection features of the base support structure (not shown).

Further, example embodiments of the rail structure with adjustable trolley 870 can be configured to be automatically adjusted via a motorized angle control and angle sensor mechanism (“sensor”) (not shown) as may be necessary to operate embodiments of the present invention in a dynamic manner. The sensor can be incorporated into the base support structure or other such structure as may be necessary, and can be defined by a switch, such as a mercury tilt switch, which can allow for the flow of electric current in an electric circuit in a manner that is dependent on the switch's physical orientation relative to a structure, such as a segment (area or rail type), support leg 874, solar panel or other structure having a known relationship with the superstructure. For example, if the base support structure or segment of same changes orientation for whatever reason, the mercury tilt switch connects electric current to activate the motorized angle control to cause the rail structure with adjustable trolley structure 870 or mechanism thereon to move in an angle and/or orientation opposite to the base support structure so as to maintain a stable orientation (e.g., vertical or angular) of the coupled superstructure.

Optionally, embodiments of the present invention can employ an internal or external electronic heating system, which can operate either manually (e.g., turned on as needed) or mechanically (e.g., in conjunction with an automatic activation device that can trigger the heating system to turn on when sensors sense precipitation or freezing temperatures), such that the mercury tilt switch, sensor, or other such device (e.g., rotational elements associated with the superstructure) that can be affected by temperature or ice can function. Alternatively, the rail structure with adjustable trolley structure 870 can be manually adjustable via a winch (or similar apparatus as is known in the art) such that the rails and other system elements can be deployed without electronic sensors or other systems.

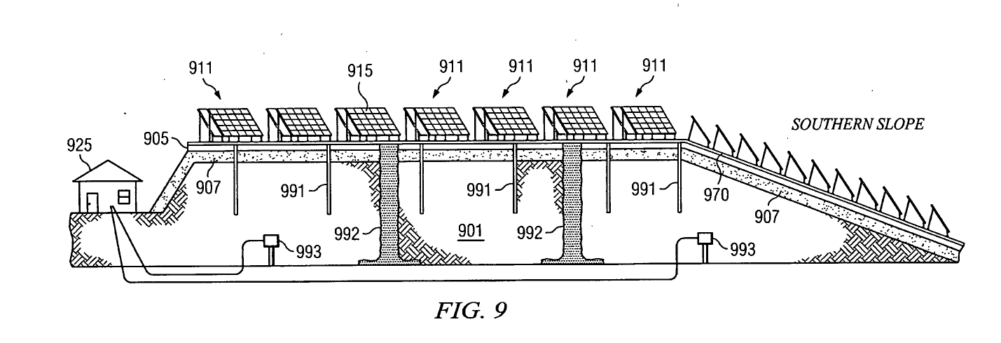

FIG. 9 is an illustration of a landfill on unstable ground 901, on which an embodiment of the present invention, which includes a rail structure and adjustable trolley structure 970, has been deployed at multiple structure sites 911.

The landfill 901 can include an energy storage facility 925 (shown in FIG. 1A and described in reference to same), methane extraction system (not shown) employing pipes 991, drainage system 992, alarm house systems for monitoring methane levels 993, and any other landfill components as is known in the art. The structure sites 911 can be distributed about the landfill 901 in a selectable manner due to ease of deployment of the segmented base support structure 905. The structure sites 911 can further be deployed on the segmented base support structures 905, such as structures 205 described in reference to FIGS. 2A-2C, may be positioned on ground treatments 907, such as one described in reference to FIG. 5. Alternatively, the structure sites 911 can include a rail structure and adjustable trolley structure 970 (see the rail structure and trolley structure 770 of FIG. 7A), which can be deployed on a ground treatment 907 on a southern-facing slope.

In some embodiments of the present invention, the rail structure and adjustable trolley structure 970 is deployed on a southern-facing slope, for maximum sun exposure, particularly if supporting static solar panels, and can include fixed superstructures 915 (e.g., with solar panel arrays) that can be adjusted seasonally to account for different conditions (e.g., solar movement). Alternatively, the superstructures can be dynamic, such that the superstructure 915 can be adjusted in a thirty degree (30°) range from East to West, or vice versa, from a nominal state. The nominal state can include a fixed point facing due south, and the 30° range can be 30 degrees to the East and/or 30 degrees to the West. Such dynamic movement of the rail structure with adjustable trolley structure 970 can include separating the trolley structures from the rail structures so as to be individually adjusted on or around the slope.

The segmented rail structure may be preferable to the segmented base support structure for slopes, including 1:1, 2:1, 3:1, or 4:1 slopes, where 1:1 refers to a slope defined by one foot out and one foot down, 2:1 refers to a slope two feet out and one foot down, and so forth). The segmented rail structure may also be used on a flat surface.

Another example embodiment of the present invention is a cementitious segmental ballast base support system useful for supporting a solar or wind power generating device on unstable grounds comprising an octagonal shape formed from two or more octagonal and segmental rings comprising: a. an inner octagonal ring made from two or more securely integrated octagonal and segmented circular parts having a center designed to contain said generating device structure, and, b. an outer octagonal ring made from segmented quadrants securely connected together and formed around said inner ring and securely attached thereto, whereby each segment of each ring is pre-cast cementitious material and each part of each ring is securely fashioned by a series of connecting points to each of said rings.

Yet another example embodiment of the present invention is a cementitious segmental ballast base support system useful for supporting a solar or wind power generating device on unstable grounds comprising a circular shape formed from two or more circular and segmental rings comprising: a. an inner circular ring made from two or more securely integrated and segmented circular parts having a center designed to contain said generating device structure, and, b. an outer circular ring made from segmented quadrants securely attached thereto, whereby each segment of each ring is pre-cast cementitious material and each part of each ring is securely fashioned by a series connecting points to each of said rings.

A further embodiment is a ballast base support system of the foregoing two embodiments wherein each of said segmented elements has a top, a bottom, an outer edge, an inner edge and two sides, wherein each of said sides is chamfered in a manner to form locking edges so that when each element adjoins another, the locking edges are mated to further ensure a tight connection. The ballast base support system may include a series of plates integrated along each of said sides on the outer edge thereof and said plates are bolted together with matching plates on adjoining elements to further ensure a tight connection. The ballast base support system may further include reinforcing elements added to the cementitious material used to form said elements and further reinforce said elements. The ballast base support may still further include a series of holes formed along said sides in a downward manner so as to permit bolts to be inserted therein and to further ensure a tight connection when elements are joined together.

While this invention has been particularly shown and described with references to example embodiments thereof, it will be understood by those skilled in the art that various changes in form and details may be made therein without departing from the scope of the invention encompassed by the appended claims.

1. An apparatus for supporting a free-standing superstructure, the apparatus comprising:
segments of a base support structure including interconnection features;
linkages configured to couple to the interconnection features in a manner interconnecting the segments which, in an interconnected state, collectively serve as the support structure to support a free-standing superstructure on an unstable ground.

2. The apparatus of claim 1 wherein the segments have defined top and bottom surfaces and further comprising a ground treatment including a layer of pliable material spanning the bottom surfaces of the segments.

3. The apparatus of claim 2 wherein the ground treatment includes a bottom layer and at least one upper layer, the bottom layer being the layer of pliable material and the at least one upper layer having sufficient adaptability to track topological state changes of the bottom layer due to topological state changes in the unstable ground beneath the bottom layer while maintaining sufficient integrity to serve as a platform upon which the base support structure continuously supports the free-standing superstructure in a substantially stable orientation across topological state changes of the unstable ground.

4. The apparatus of claim 3 wherein the segments include multiple grips protruding from the bottom surface configured to interact with the at least one upper layer of the ground treatment in a manner enabling the segments to resist lateral movement.

5. The apparatus of claim 2 wherein the pliable material is liquid permeable.

6. The apparatus of claim 2 wherein the pliable material has a tensile strength able to withstand movement of the first and second segments relative to each other over a predetermined range.

7. The apparatus of claim 1 wherein the base support structure is configured to support the free-standing superstructure in a substantially stable orientation during occurrences of extreme natural forces acting upon the superstructure, including high wind, earthquake, and blizzard conditions.

8. The apparatus of claim 1 wherein the segments are configured to change orientation relative to other segments as a function of the linkages and interconnection features.

9. The apparatus of claim 8 wherein forces transmitted into a first subset of segments by the free-standing superstructure are transmitted into a second subset of segments at a reduced level as a function of the linkages and interconnection features.

10. The apparatus of claim 1 wherein a first subset of segments are enclosed by a second subset of segments.

11. The apparatus of claim 10 wherein the first and second subsets of segments are circular.

12. The apparatus of claim 10 wherein the first and second subsets of segments are non-circular.

13. The apparatus of claim 1 wherein multiple segment elements compose each of the segments and wherein the linkages are configured to couple adjacent segment elements of the same size to each other and adjacent segment elements of different sizes from each other.

14. The apparatus of claim 13 wherein the multiple segment elements composing the segments of the same size are interchangeable.

15. The apparatus of claim 13 wherein the multiple segment elements are each configured to be separable from and reattachable to corresponding segment elements of the base support structure.

16. The apparatus of claim 1 wherein a first subset of segments are not enclosed by a second subset of segments, and vice-versa.

17. The apparatus of claim 1 wherein the segments of the base support structure are a base tier of segments configured to support an upper tier of segments, the upper tier of segments being configured to reside between the base support structure and the free-standing superstructure, wherein segments of the upper tier of segments are coupled to the base support structure via inter-tier linkages and configured to support coupling of the free-standing superstructure to themselves.

18. The apparatus of claim 1 wherein the segments of the base support structure are cementitious.

19. The apparatus of claim 1 wherein the segments are rail structures to which an adjustable trolley structure, wherein the trolley structure is configured to support a superstructure or superstructure element.

20. The apparatus of claim 1 wherein the interconnection features include at least one of the following: chamfers, sockets, cylinders, or interconnected locks.

21. The apparatus of claim 1 wherein the linkages include at least one of the following: chamfers, bolts, latches, cables, grips, or interconnected locks.

22. The apparatus of claim 1 further comprising couplings configured to enable the free-standing superstructure to be coupled to the base support structure, wherein the couplings are selected from a group consisting of: chamfers, bolts, sockets, latches, cylinders, interconnected locks, straight holes, tapered holes, clamps, guy-wires, cables, hinges, and ball joints.

23. The apparatus of claim 1 wherein the free-standing superstructure includes a renewable energy power generation device.

24. The apparatus of claim 22 wherein the renewable energy power generation device includes at least one of the following devices: solar panels, solar arrays, photovoltaics, solar cells, heat engines, wind turbines, or biomass converters.

25-53. (canceled)
